(19) United States
(12) Patent Application Publication
(10) Pub. No.: US 2012/0226542 A1
(43) Pub. Date: Sep. 6, 2012

(54) PROVIDING COUPONS VIA A MOBILE DEVICE

(75) Inventors: Nicholas Blosser, Portland, OR (US); Greg Keene, Portland, OR (US); James Keller, Portland, OR (US); Raven Zachary, Portland, OR (US); Jennifer Adams, Portland, OR (US)

(73) Assignee: Celilo Group Media, Portland, OR (US)

(21) Appl. No.: 13/356,566

(22) Filed: Jan. 23, 2012

Related U.S. Application Data
(63) Continuation of application No. 13/038,256, filed on Mar. 1, 2011.

(51) Int. Cl. G06Q 30/02

(52) U.S. Cl. 705/14.25; 705/14.26; 705/14.1

(57) ABSTRACT

A facility for distributing electronic coupons is described. The facility presents to a user indications of each of at least one coupon pack. Each coupon pack comprises a plurality of independently-redeemable electronic coupons. The facility receives user input selecting an indicated coupon pack, and uses payment information associated with the user to collect a price indicated for the selected coupon pack. The facility then makes the selected coupon pack available for use by the user such that the user may redeem any of the electronic coupons of the selected coupon pack.

### CROSS REFERENCE TO RELATED APPLICATION

This application is a continuation application of U.S. patent application Ser. No. 13/038,256, filed on Mar. 1, 2011, and entitled “PROVIDING COUPONS VIA A MOBILE DEVICE,” which is incorporated herein in its entirety by reference.

### TECHNICAL FIELD

The described technology is directed to the field of mobile device tools for facilitating commerce.

### BACKGROUND

Coupons are instruments that entitle their bearers to special deals from particular merchants. For example, a coupon issued by a coffee shop might entitle its bearer to two beverages for the price of one, or a free muffin with a beverage, or 20% off the price of a beverage.

Coupons have historically been printed on paper, either in specialized coupon books, or as part of other publications such as newspapers and magazines. In order too redeem such a coupon, a customer typically tears it out of another publication in which it was printed and hands it to the cashier at the merchant, who in response provides the deal indicated by the coupon to the customer.

If the merchant wishes to track the use of coupons by its customers, it typically does so manually, relying on its own employees.

### BRIEF DESCRIPTION OF THE DRAWINGS

FIG. 1 is a network diagram showing an arrangement of components used to provide the facility in some embodiments.

FIG. 2 is a block diagram showing some of the components typically incorporated in at least some of the computer systems and other devices on which the facility operates.

FIGS. 3A-3G contain a flow diagram showing steps performed by the facility in some embodiments in order to provide the experience of purchasing, selecting, and redeeming coupons on a mobile device.

FIGS. 4-57 are display diagrams each depicting a sample display presented by the facility in some embodiments.

FIG. 58 is a report diagram showing a sample coupon redemption report typical of those generated for a merchant by the facility in some embodiments.

### DETAILED DESCRIPTION

The inventors have identified substantial disadvantages in conventional approaches to publishing and redeeming coupons. As a first matter, it requires significant effort for a customer to remember to bring coupons along when the customer leaves the house, and to carry the coupons, which may be in one or more large books, a file folder, or a zip-closure bag. It is also difficult for the customer to recognize opportunities to use coupons—such as when the customer arrives at a merchant for which he or she has a coupon—and to be able to locate the correct coupon among the many coupons that he or she is carrying. Also, when proceeding conventionally, it is virtually impossible for the customer to select a particular merchant for a buying task (e.g., a caramel latte) on the basis of whether the customer has a coupon for any merchant that could satisfy that buying task. It can also be difficult for a customer to determine whether the customer has a coupon for any merchant near whatever location the customer finds him or herself in. Also, where coupons are shared by two or more people such as spouses or an entire family, only one of these people at a time can physically possess a particular coupon, and the ability to redeem that coupon is limited to the person who possesses it, preventing any others with whom it is shared from redeeming it.

The inventors have also identified substantial disadvantages in conventional approaches to publishing and redeeming coupons from the merchant's perspective. First, it is often relatively easy for customers to counterfeit paper coupons, such as by copying them with a photocopier. Such counterfeiting can tend to make a coupon campaign more expensive without generating a corresponding increase in sales. Also, it can be extremely burdensome for a merchant to track and analyze coupon redemptions to determine the frequency of redemption at certain locations, during certain date and time ranges, among different coupons, etc. Finally, printing coupons on paper and physically distributing these paper coupons can incur a significant resource cost and associated pecuniary expense.

Seeking to overcome these disadvantages, the inventors have designed a hardware and/or software facility for providing coupons via a mobile electronic device such as a wireless phone (“the facility”). In some embodiments, a customer (“user”) installs a coupon application on his or her mobile device. The user uses the application to establish an account with the facility; purchase or otherwise obtain one or more “packs” of coupons, such as packs of coupons each for a merchant having one or more locations in a particular geographic area; identify purchased coupons likely to prove useful; and redeem identified coupons with the corresponding merchants. Electronic coupons of this type can typically be created, circulated, and used at resource costs and pecuniary expenses that are both significantly less than those for paper coupons.

In some embodiments, the user can for inclusion in a list of favorite coupons, making them more accessible for identification and/or redemption in this way.

In various embodiments, the facility provides various techniques for identifying coupons likely to prove useful, such as by combinations of one or more of the following: listing all available coupons; listing only coupons in a merchant category selected by the user; listing only coupons matching a search string specified by the user; listing coupons based upon the distance to the merchant from the user's present location; listing all coupons that might be of interest to the user based upon the user's favorite coupons or previous coupon redemptions; listing all coupons that might be of interested based upon their membership in or affiliation with an organization; and sorting listed coupons based upon some attribute, such as merchant name, deal type, expected amount of savings, merchant type, distance to the merchant from the user's current location, etc.

In some embodiments, multiple users and/or multiple mobile devices may share a single account with the facility, such that any coupon purchased or obtained for the account is available for identification and redemption by any of the sharing users and/or mobile devices.

In some embodiments, the facility causes a special animation to be played as part of a redemption display that is presented on the mobile device when its user redeems a coupon. This animation, whose appearance changes as it is displayed, prevents customers from counterfeiting coupons by simply capturing and re-displaying a still image of the redemption display.

In some embodiments, a user who has purchased a coupon can transfer that coupon to a different user or account, such as by wirelessly transmitting the coupon to the receiving user's mobile device.

In some embodiments, the facility generates for some or all merchants who publish coupons with the facility redemption reports that detail the redemption of each coupon published by the merchant and each merchant location during one or more date, day, and/or time range.

By behaving in one or more of these ways, the facility makes the process of using coupons easier for customers; more useful to merchants; and less resource intensive.

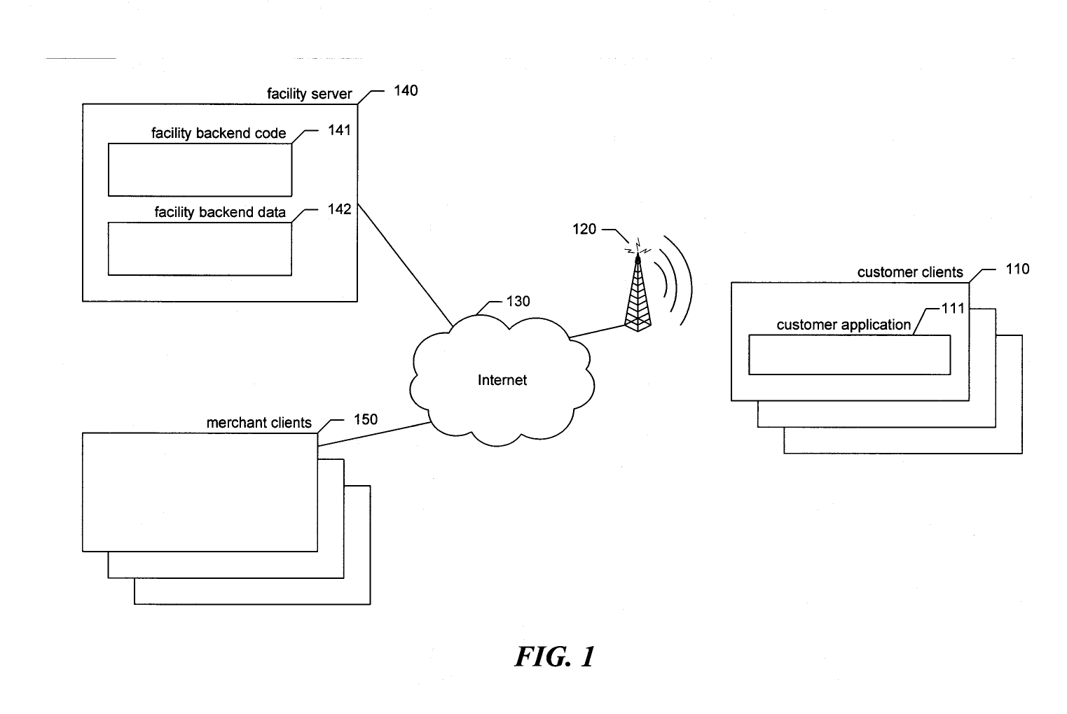

FIG. 1 is a network diagram showing an arrangement of components used to provide the facility in some embodiments. Customers interact with a customer application 111 executing on a number of customer clients 110—such as smartphones or similar mobile devices—to purchase coupon packs and find and redeem coupons. The customer application communicates wirelessly, such as via a wireless base station 130, and then via the Internet 140 or other network, with a facility server 140. The facility server stores account information, receives and processes payment information, and provides coupon packs and supporting data. The facility server includes both facility backend code 151 and facility backend data 152.

The facility server also produces coupon purchase and/or redemption reports that can be retrieved from the facility server and reviewed by merchants using merchant clients 150.

In various embodiments, various aspects of functionality attributed to the facility server above are distributed to customer clients. While various embodiments are described in terms of the environment described above, those skilled in the art will appreciate that the facility may be implemented in a variety of other environments including a single, monolithic computer system, as well as various other combinations of computer systems or similar devices connected in various ways.

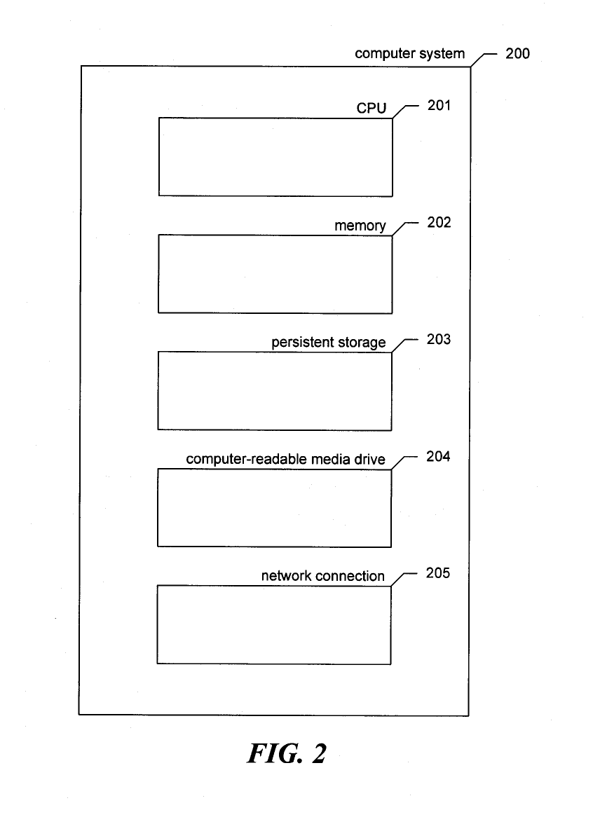

FIG. 2 is a block diagram showing some of the components typically incorporated in at least some of the computer systems and other devices on which the facility operates. In various embodiments, these computer systems and other devices 200 can include server computer systems, desktop computer systems, laptop computer systems, mobile phones, personal digital assistants, tablet computers, televisions, cameras, automobile computers, automobile computers interacting in a wireless and/or wired manner with another device carried into the automobile such as a mobile phone or laptop computer system, electronic media players, etc. In various embodiments, the computer systems and devices include zero or more of each of the following: a central processing unit (“CPU”) 201 for executing computer programs; a computer memory 202 for storing programs and data while they are being used; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet, a wireless network, or another network and its networking hardware. While computer systems configured as described above are typically used to support the operation of the facility, those skilled in the art will appreciate that the facility may be implemented using devices of various types and configurations, and having various components.

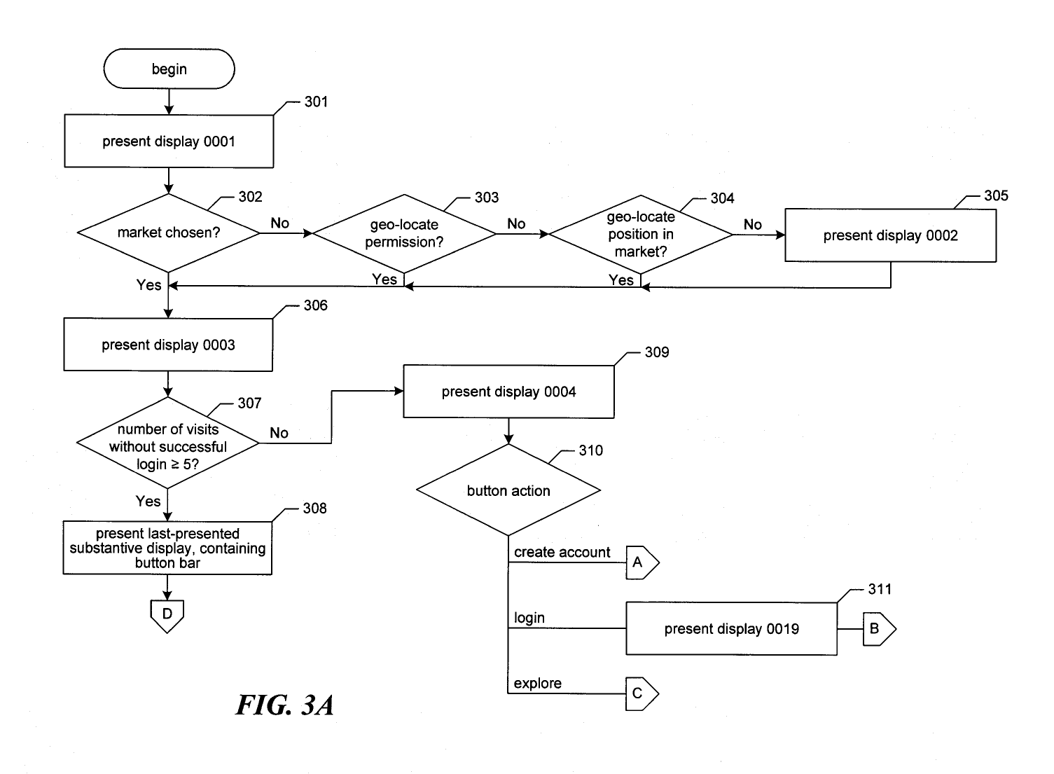

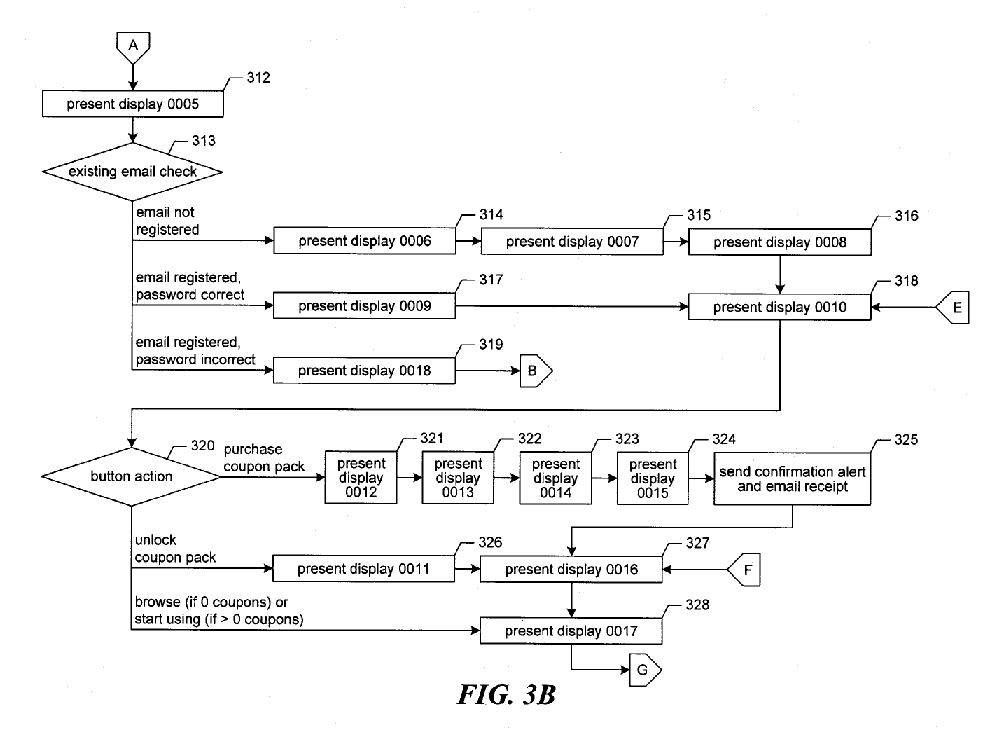

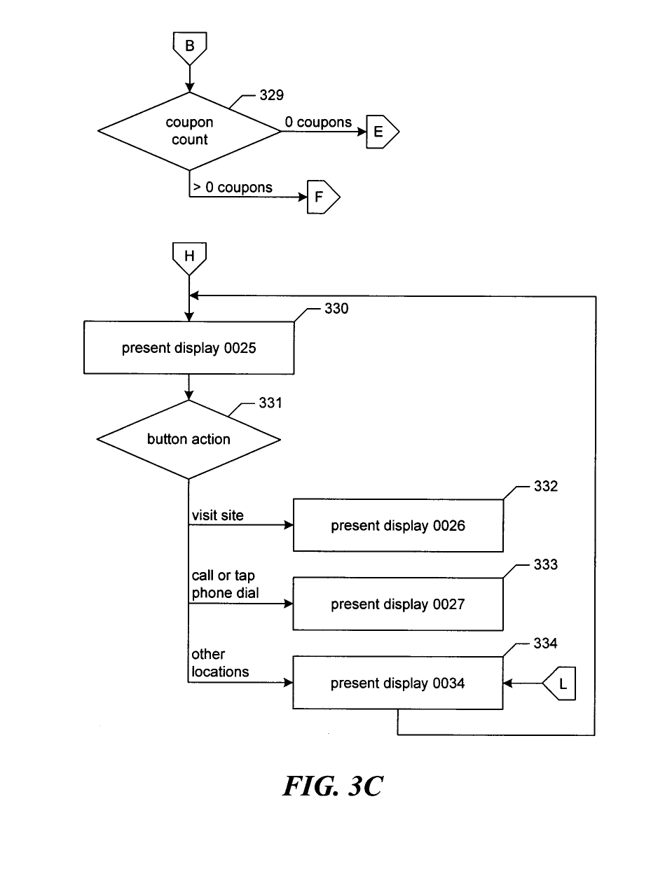

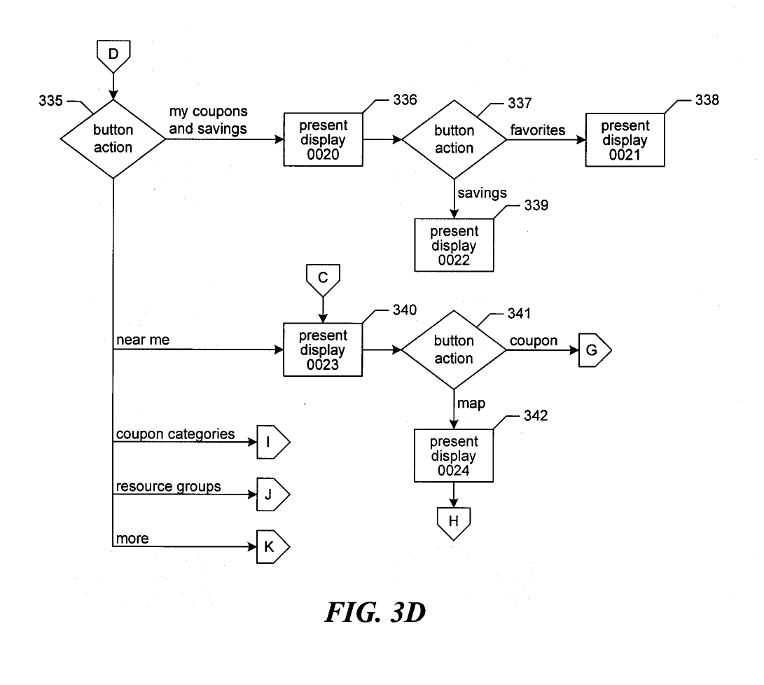

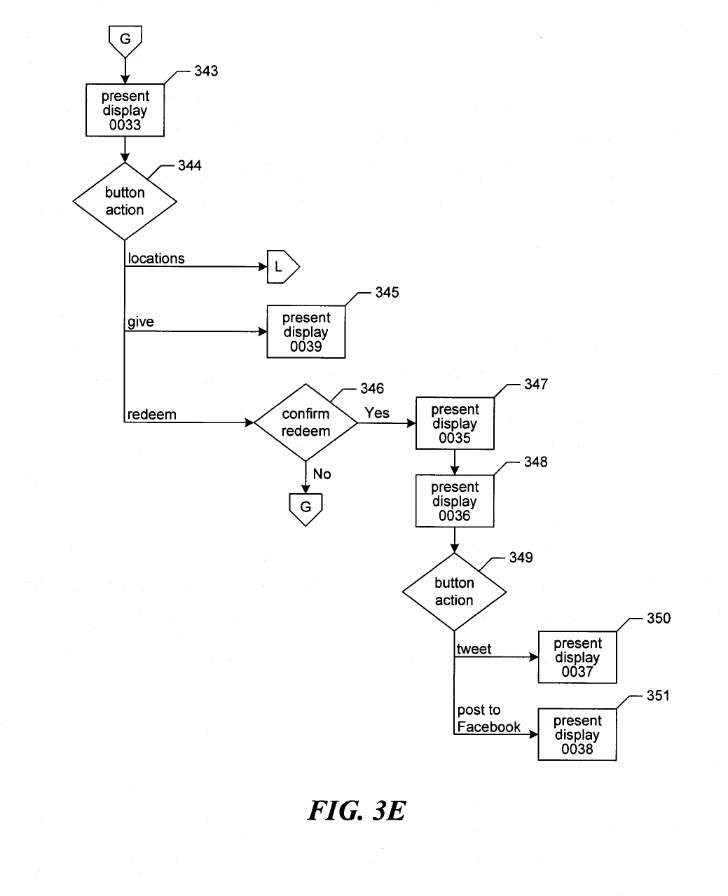

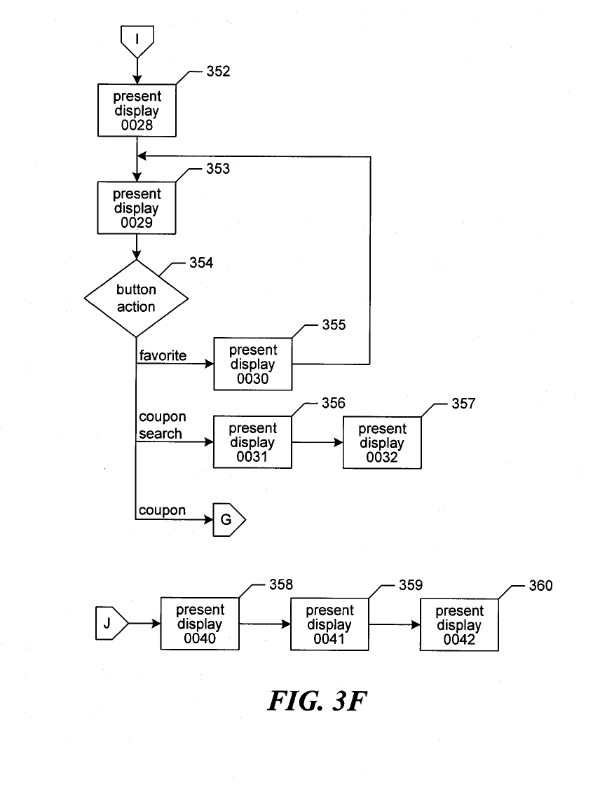

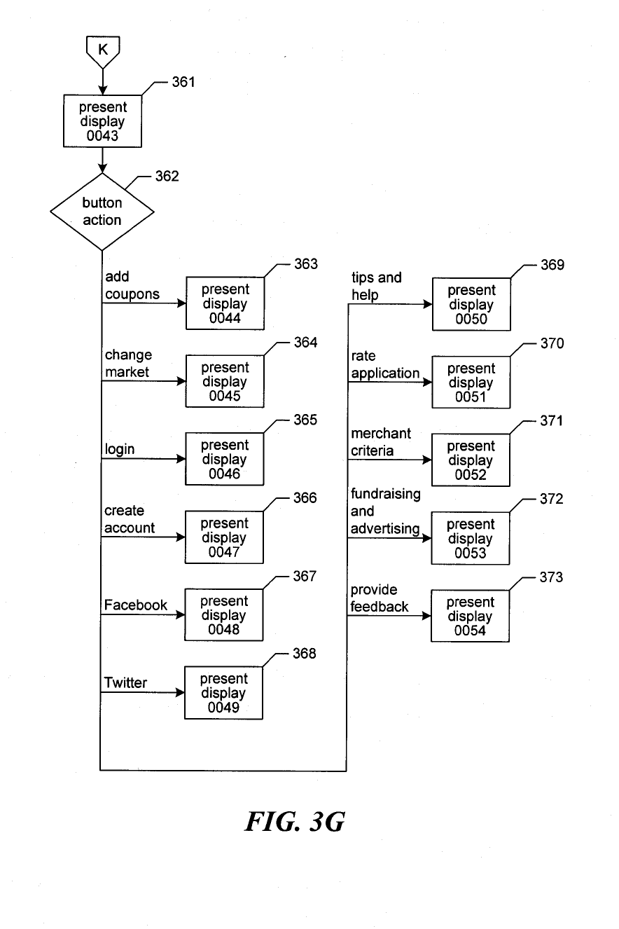

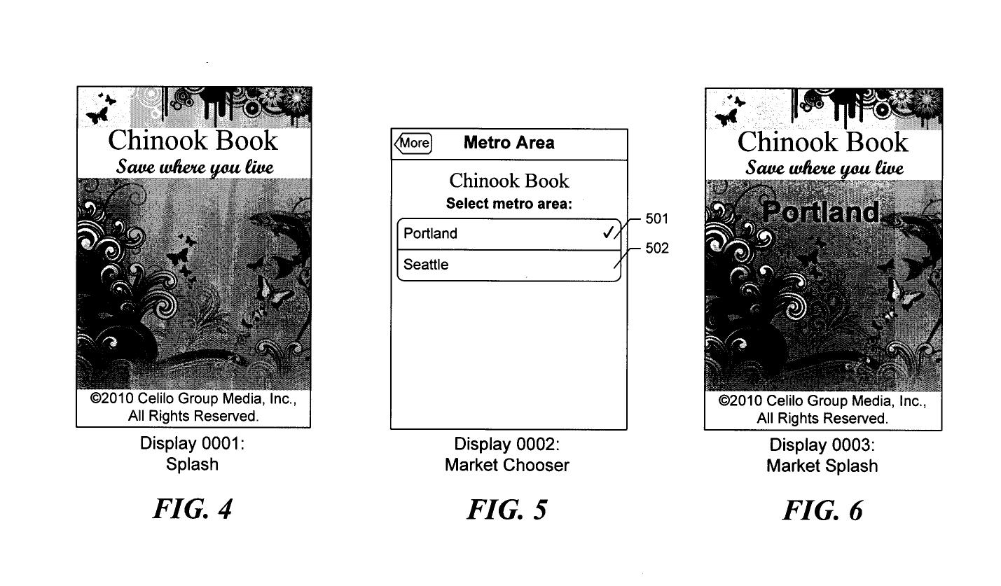

FIGS. 3A-3G contain a flow diagram showing steps performed by the facility in some embodiments in order to provide the experience of purchasing, selecting, and redeeming coupons on a mobile device. In step 301, the facility presents display 0001, an initial splash screen. In step 302, if a market—i.e., a particular geographic area, such as a particular metropolitan area—in which to use the facility has already been selected by the user, then the facility continues in step 306, else the facility continues in step 303. If the facility and/or the device has received permission from the user to perform geolocation and use the resulting location within this application, then the facility continues in step 306, else the facility continues in step 304. In step 304, if the position produced by performing geolocation is in a supported market, then the facility continues in step 306, else the facility continues in step 305. In step 305, the facility presents display 0002, shown in FIG. 5. Display 0002 is a market chooser display, in which the user can select a button among buttons 501 and 502 in order to select a market in which to use the facility.

In step 306, the facility presents display 0003, shown in FIG. 6. This display is a market splash screen identifying the market selected for the user's use of the facility. In step 307, if the user's number of visits without a successful login is greater than or equal to 5, then the facility continues in step 308, else the facility continues in step 309. In step 308, the facility presents the last substantive display of the facility that was presented the last time the user was logged in. In some or all cases, the display presented in step 308 includes a button bar that the user may use in order to select high-level functionalities of the facility. For example, display 0017 shown in FIG. 20 includes button bar 2060. The button bar includes a button 2061 for my coupons and savings, a button 2062 for near me, a button 2063 for coupon categories, a button 2064 for resource groups, and a button 2065 for more functionalities. After step 308, the facility continues through connector D to step 335 shown in FIG. 3d to act on user's selection of a button in the button bar.

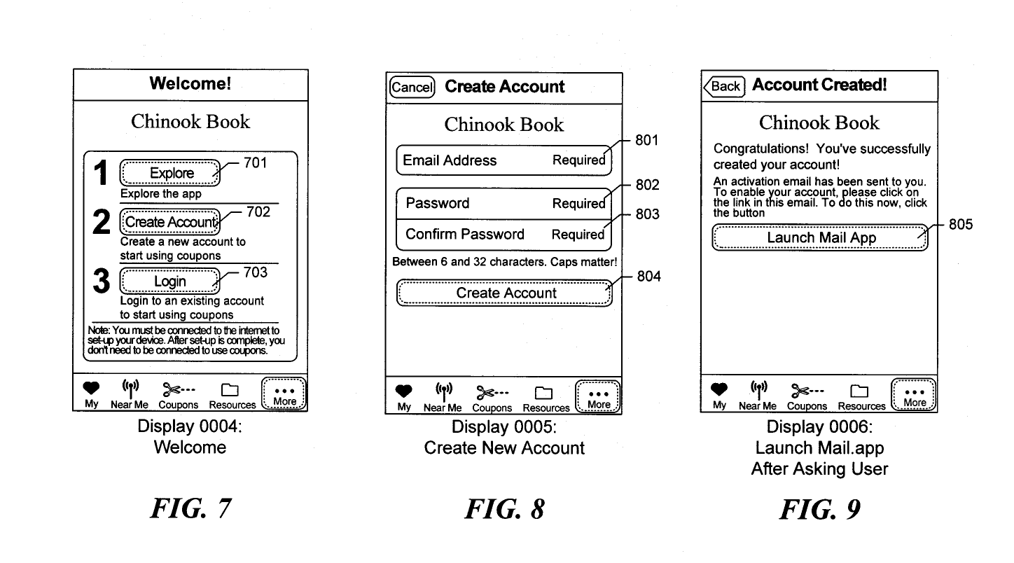

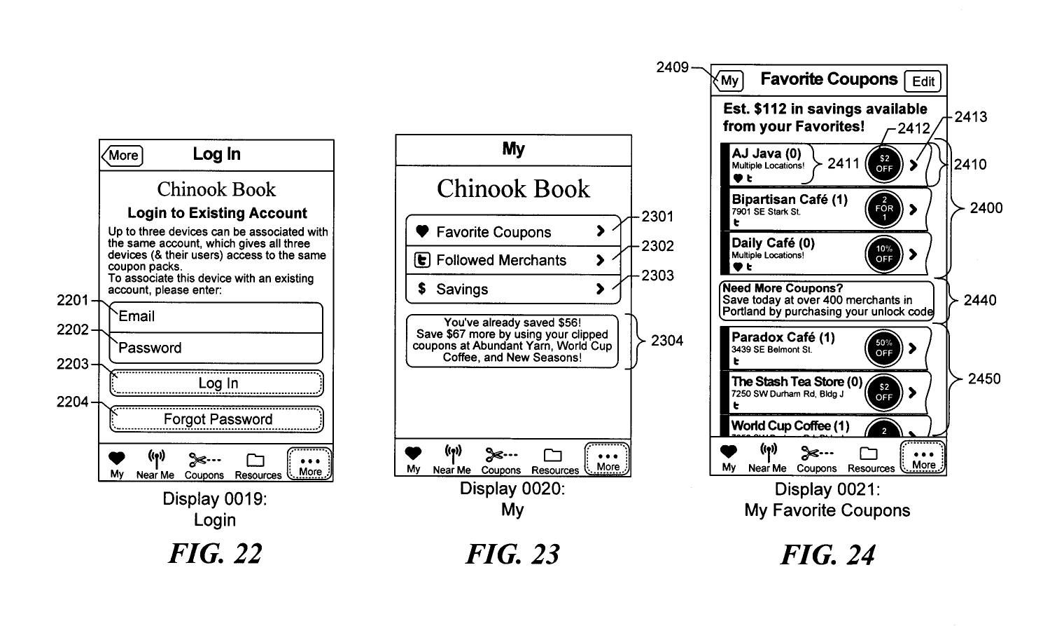

In step 309, the facility presents display 0004, shown in FIG. 7. Display 0004 is a welcome display, and includes an explore button 701 that the user can select in order to explore aspects of the facility; a create account button 702 that the user can select in order to create an account for use with the facility; and a login button 703 that the user may select in order to log in to the facility. In step 310, the facility branches based upon the button selected by the user: if the user selects the create account button, the facility continues through connector A to step 312 shown in FIG. 3B; if the user selects the login button, the facility continues in step 311; if the user selects the explore button, the facility continues through connector C to step 340 shown in FIG. 3D. In step 311, the facility presents display 0019, shown in FIG. 22. In order to log in, the user enters their email address and password in fields 2201 and 2202, respectively, then selects button 2203. The user can also select button 2204 if the user has forgotten his or her password. After step 311, the facility continues through connector B to step 329 shown in FIG. 3C.

Continuing in FIG. 3B, in step 312, the facility presents display 0005 shown in FIG. 8. Display 0005 is a create new account display. The user can enter their email address into field 801, and a password for accessing the facility into both fields 802 and 803, then select a create account button 804 in order to create an account with the facility. In step 313, the facility branches based upon an analysis of the login information answered by the user in display 0005: if the email address is not registered, the facility continues in step 314; if the email address is registered and the password in correct, then the facility continues in step 317; if the email address is registered and the password is incorrect, then the facility continues in step 319.

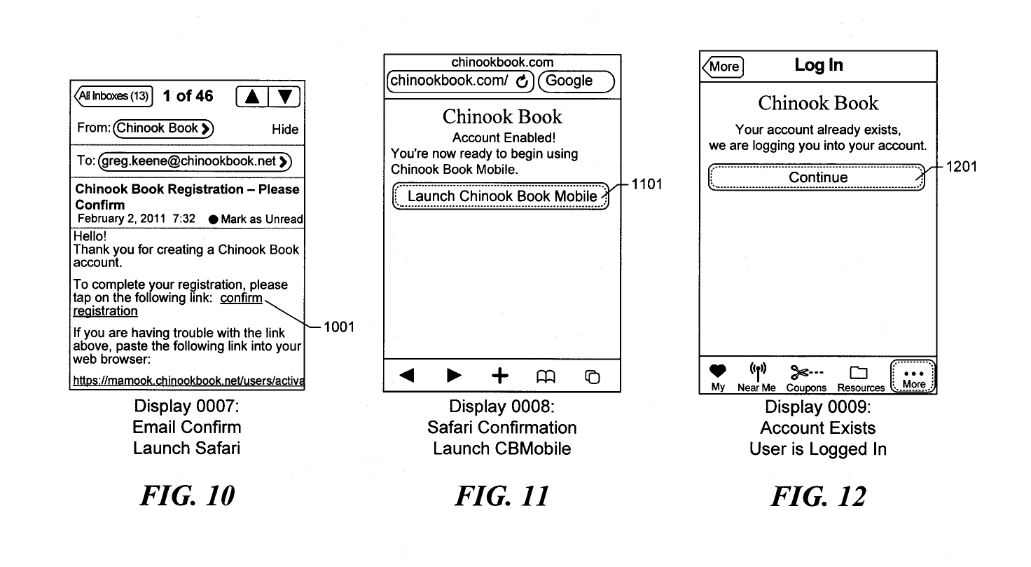

In step 314, the facility presents display 0006, shown in FIG. 9. Display 0006 is a display that enables the user to launch an email application in order to review and act on an activation email sent by the facility in response to the user's creation of a new account. In step 315, the facility presents display 0007, shown in FIG. 10. This display is an email confirmation display containing an email message addressed to the user at the entered email address. The message includes a confirmation link 1001 that the user may select in order to confirm their registration with the facility. When the user selects the confirmation link, the facility continues in step 316 to present display 0008, shown in FIG. 11. This display is a confirmation display confirming that the creation of a new account has been successfully completed. It includes a launch button 1101 that the user can select in order to begin their substantive use of the facility. After step 316, the facility continues in step 318.

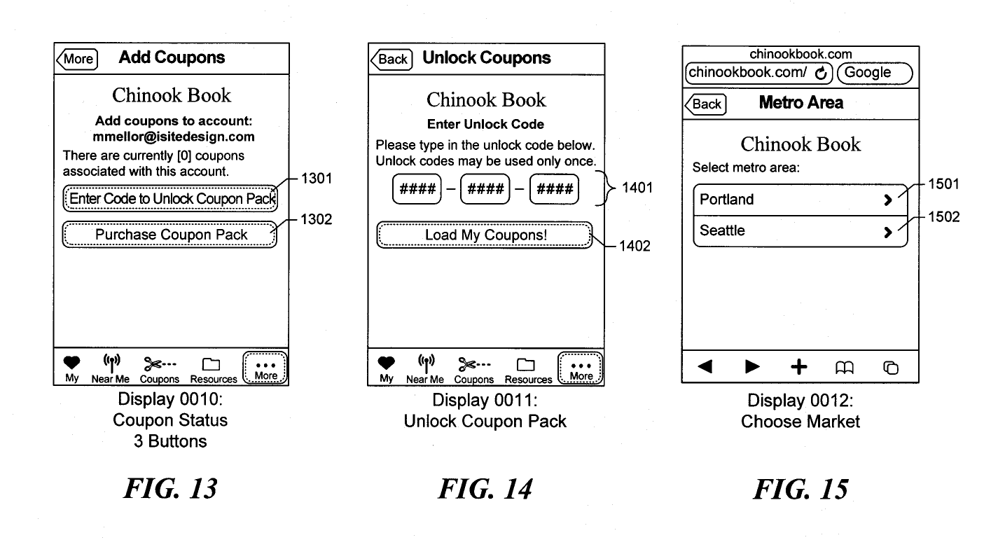

In step 317, the facility presents display 0009, shown in FIG. 12. This display includes a message that the user has already created an account, and is being logged into it. The display includes a continue button 1201 that the user may select in order to proceed with their substantive use of the facility. In step 318, the facility presents display 0010, shown in FIG. 13. This display permits the user to either unlock or purchase a coupon pack, by selecting button 1301 or 1302, respectively. After step 318, the facility continues in step 320 to branch on the identity of the button selected by the user.

In step 319, the facility presents display 0018, shown in FIG. 21. This display includes a message that an account already exists for the email address entered by the user in display 0005, but the password entered into that display by the user was incorrect. The display further includes email and password fields 2101 and 2102, respectively, as well as login and forgot password buttons 2103 and 2104, respectively, which operate in the same manner as the corresponding buttons in display 0019 shown in FIG. 22 and discussed above. After step 319, the facility continues through connector B in step 329.

In step 320, the facility branches based upon the button selected in display 0010 shown in FIG. 13: if the user selected the purchase coupon pack button, then the facility continues in step 321; if the user selected the unlock coupon pack button, then the facility continues in step 326; and if the user selected a browse or start using button, then the facility continues in step 328.

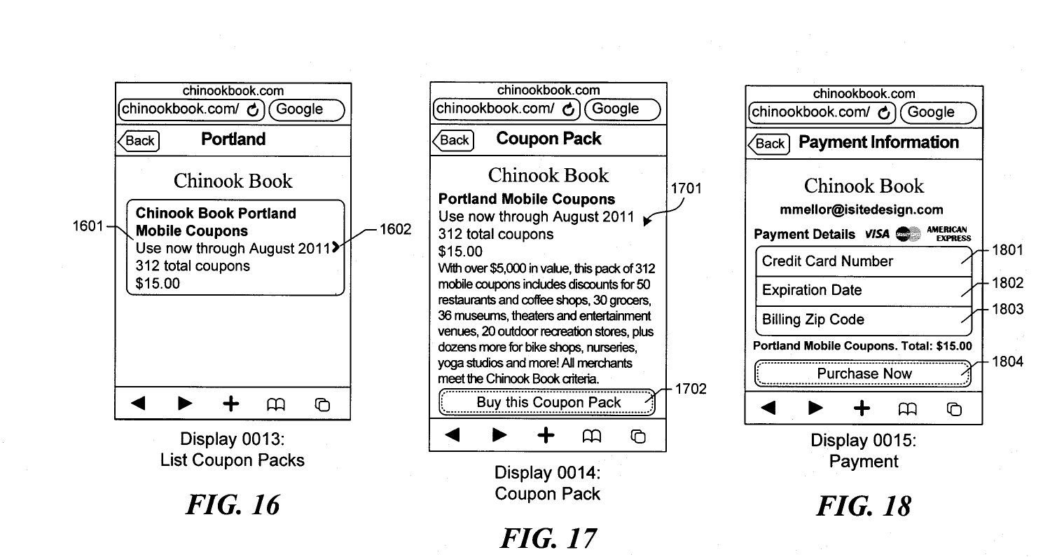

In step 321, the facility presents display 0012, shown in FIG. 15. This display, like display 002 shown in FIG. 5, permits the user to select a market. In step 322, the facility presents display 0013, shown in FIG. 16. This display includes a button for each coupon pack available for purchase in the market selected by the user in display 0012. Here, for the market Portland, only one coupon pack is available for purchase. Its summary information is included in button 1601. The user can select any of the displayed buttons in order to display detailed information about the corresponding coupon pack. In step 323, the facility presents display 0014, shown in FIG. 17. This display includes additional information about 1701 about the select coupon pack, as well as button 1702 that the user can select in order to purchase this coupon pack. In step 324, the facility presents display 0015, shown in FIG. 18. This display solicits payment information from the user for use to purchase the select coupon pack. It includes fields 1801-1803 into which the user may enter their credit card number, expiration date, and billing zip code, respectively. After doing so, the user selects a purchase button 1804 in order to make the purchase. In step 325, the facility sends the confirmation order in an email receipt in response to the purchase. After step 325, the facility continues in step 327. In some embodiments (not shown), the facility also or instead provides an option for the user to obtain a periodic subscription to the coupon pack as contrasted with purchasing it outright. In addition, in some embodiments (not shown), in connection with the acquisition of a coupon pack, the facility provides an opportunity for the acquiring user to enter an associate code identifying an organization—such as a nonprofit organization—that promoted the coupon pack to the user, and who is to receive a share of the revenue received in connection with the acquisition of the coupon pack. This helps to facilitate a marketing of coupon packs by nonprofit organizations as a fundraising activity.

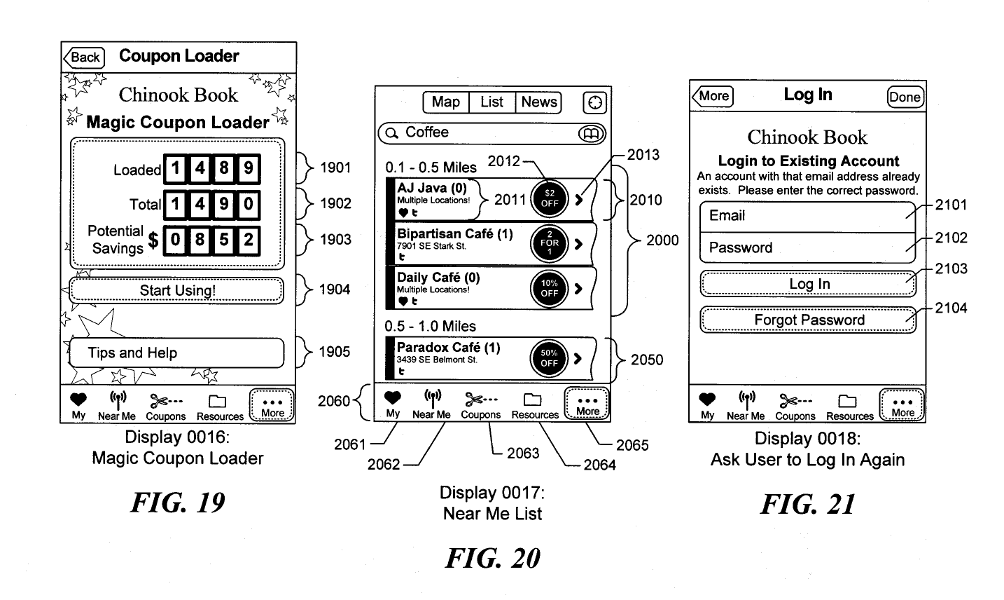

In step 326, the facility presents display 0011, shown in FIG. 14. This display is used by a user to enter an unlock code for a coupon pack purchased separately, received as a promotional consideration, etc. In some embodiments (now shown), the facility provides a mechanism for a user to convey to other users a promotional redemption code, such as for a limited set of coupons. In various embodiments, the user can provide this promotional redemption code to other users via such communications mechanisms as email, SMS, Facebook, Twitter, etc. The display includes fields 1401 into which the user enters an unlock code that has been provided to the user, as well as a button 1402 that the user selects in order to complete the unlocking of a coupon pack. In step 327, the facility presents display 0016, shown in FIG. 19, which contains information 1901-1903 about the coupon pack. In some embodiments, when presenting display 0016, the facility begins by displaying a number of loaded coupons 1901, number of total coupons 1902, and value of potential savings 1903 that reflects the state of these values before loading the coupon pack; then animates the increasing of each of these values to represent the “loading” of the coupon pack into the client, ultimately arriving at the state of each value that represents the complete loading of the coupon pack. This display includes start using button 1904 that the user can select in order to start using the coupon pack, as well as a tips and help button 1905 that the user can select in order to obtain tips and help for using the coupon pack. After step 327, the facility continues in step 328.

In step 328, the facility presents display 0017, shown in FIG. 20. This display includes a list of coupons for merchants who are geographically near to the user's present location as determined by the global device such as using gps or other locating means. The display includes, for each of a number of radius ranges, a list of merchants within that radius range from the user having coupons in the coupon pack. For example, section 2000 includes information about merchants that are in a radius range of 0.1 miles to 0.5 miles from the user. Entry 2010 in this section contains information 2011 about the merchant, information 2012 about the coupon, and an indication 2013 that this entry can be selected as a button in order to display additional information about this merchant and coupon. When the user selects a merchant and coupon in display 0017, the facility continues through connector G to step 343 shown in FIG. 3E.

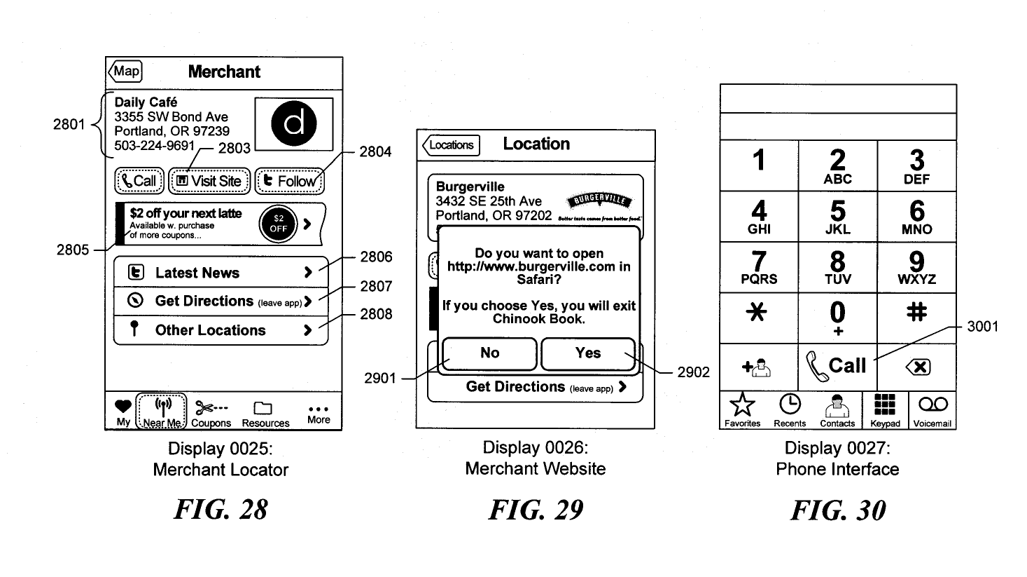

Turning to FIG. 3C, in step 329, if the number of active coupons is zero, then the facility continues through connector E to step 318 shown in FIG. 3B, else the facility continues through connector F to step 327 also shown in FIG. 3B. In step 330, the facility presents display 0025, shown in FIG. 28. This display provides information about a merchant, including name, address and phone number information 2801, as well as a logo or other image associated with the merchant. In some embodiments (not shown), this display provides further information about the merchant, including, for example, a description of the merchant, the merchant's hours of operation, an indication of the number of times users have redeemed coupons from the merchant or selected coupons from the merchant as their favorites, and/or a rating based upon the number of times users have redeemed coupons from the merchant or selected them as favorites. The display also contains information 2804 about the terms of the offer to which the coupon corresponds. The display also includes buttons for calling the merchant (2802), visiting the merchant's website (2803), following the merchant on Twitter (2804), displaying the merchant's Twitter feed (2805), getting directions to the merchant (2806), and displaying other locations of the merchant (2807). In step 331, the facility branches based upon the button selected by the user: if the user selects the visit site button, then the facility continues in step 332; if the user selects the call button or taps a dialing control, then the facility continues in step 333; if the user selects the other locations button, then the facility continues in step 334; and if the user selects any of the other buttons in the display, the facility proceeds in an appropriate manner. In step 332, the facility presents display 0026, shown in FIG. 29. This display allows the user to confirm whether to switch to a web browser application in order to display the merchant's website. If the user selects a yes button 2902, the facility proceeds to launch the web browser application to display the merchant's web site; the user selects a no button 2901, the facility returns to step 330 to again present display 0025.

In step 333, the facility presents display 0027, shown in FIG. 30. In some embodiments (not shown), the facility pre-populates this display with the phone number of the merchant, and the user can select a call button 3001 to place a call to the merchant. After step 333, the facility returns to step 330 and again presents display 0025.

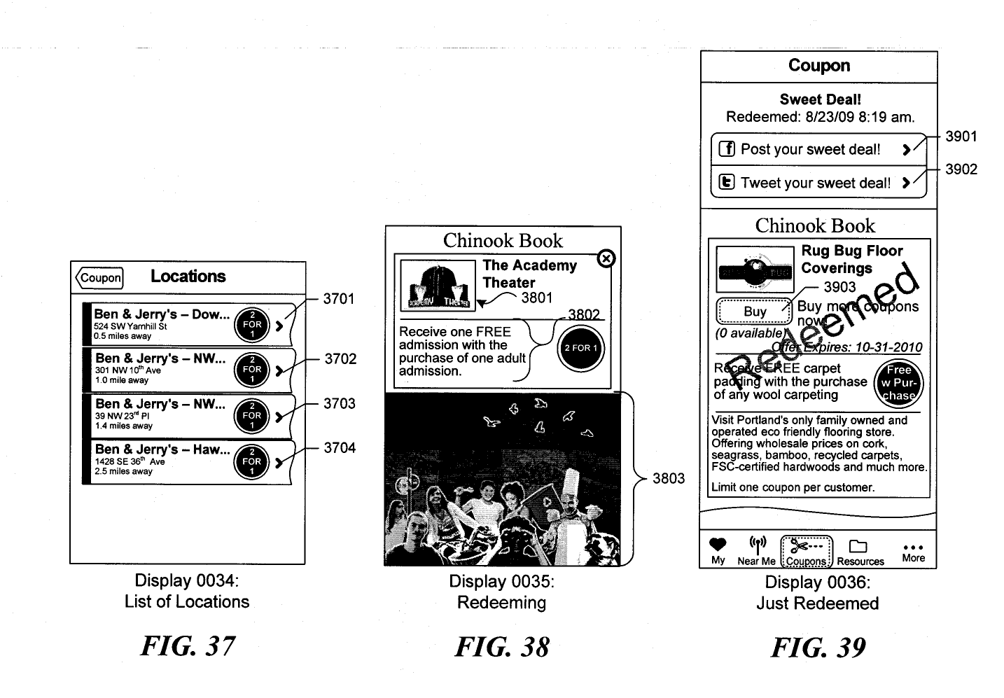

In step 334, the facility presents display 0034, shown in FIG. 37. This display includes a list of all of the merchant's locations, shown here as locations 3701-3704. The user can select one of these buttons to select a particular location of the merchant, or may select button 3700 to continue in step 330 and again present display 0025.

Continuing in FIG. 3D, in step 335, the facility branches based on the button earlier selected by the user: if the user selected a my coupons and savings button, the facility continues in step 336; if the user selected a near me button, then the facility continues in step 340; if the user selected the coupon categories button, then the facility continues through connector I to step 352, shown in FIG. 3F; if the user selected a resource groups button, then the facility continues through connector J to step 358 shown in FIG. 3F; and if the user selected the more button, then the facility continues through connector K to step 361 shown in FIG. 3G.

In step 336, the facility presents display 0020, shown in FIG. 23. This display allows the user to access information about various individualized aspects of the facility. It includes a button 2301 that the user can select in order to display the user's favorite coupons; a button 2302 that the user can select in order to display the user's favorite merchants; and a button 2303 that the user may select in order to display the user's savings from using the facility. The display also includes information 2304 about the amount of money saved by the user by using the facility. In step 337, the facility branches based upon the button selected by the user: if the user selects a favorite button, then the facility continues in step 338; if the user selects the savings button, then the facility continues in step 339. In step 338, the facility presents display 0021, shown in FIG. 24. This display lists coupons identified by the user as being among their favorite coupons. This list, shown in sections 2420 and 2450 of the display, includes information about each of the favorite coupons, presented in a button that the user can select in order to display more details about the coupon. The display also includes a button 2440 that can be used to purchase additional coupons. The user may also select a button 2400 to continue in step 336 to again present display 0020.

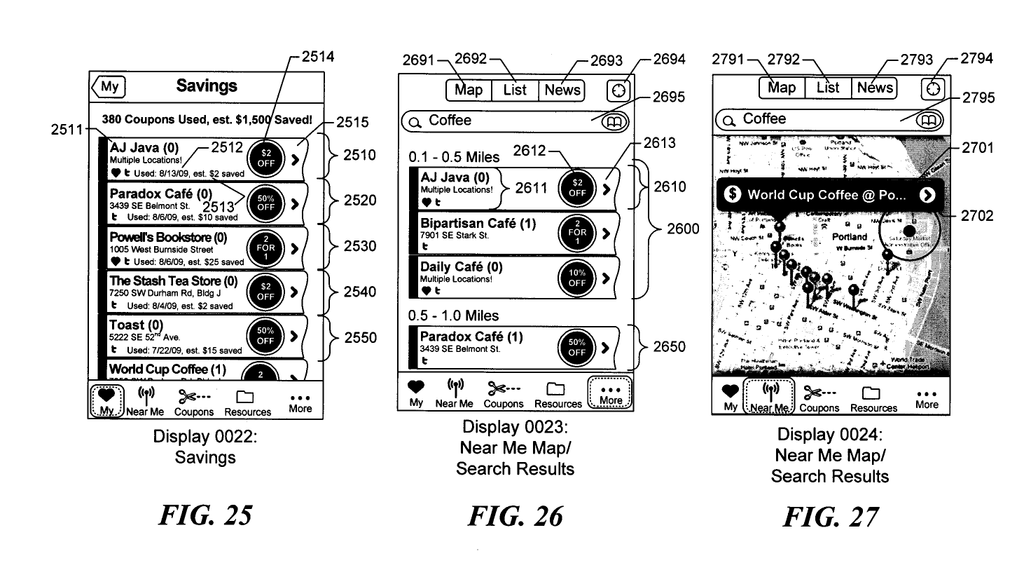

In step 339, the facility presents display 0022, shown in FIG. 25. The display lists, for each coupon redeemed by the user, when it was redeemed, and the amount of money that was saved as a result, among coupons such as coupons 2510, 2520, 2530, 2540, and 2550.

In step 340, the facility presents display 0023, shown in FIG. 26. Like display 0017, shown in FIG. 20, this display presented lists of merchants who are within different radius ranges of the user's current location. The display also includes a map button 2691 that the user may select in order to see the merchants near the user's present location displayed on a map; a list button 2692 that the user can select in order to present display 0023; and a news button 2693 that the user can select in order to display news about nearby merchants. The user may also type search text into a field 2695 to filter the displayed list of nearby merchants in order to only display those that relate to a particular term, such as “coffee.” In step 341, the facility branches based upon the button selected by the user in display 0023: if the user selects a coupon button for one of the nearby merchants, then the facility continues through connector G to step 343; if the user selects the map button, then the facility continues in step 342. In step 242, the facility presents display 0024, shown in FIG. 27. This display includes a map of the region surrounding the user's present location, on which are shown pushpins each corresponding to the location of a nearby merchant. The user can select one of these pushpins to display additional information 2701 about the corresponding merchant. The additional information includes a button 2702 that the user can select in order to display details about the merchant. When the user selects a button, the facility continues through connector H in step 330 shown in FIG. 3C to present display 0025.

Turning to FIG. 3E, in step 343, the facility presents display 0033, shown in FIG. 36. This display contains full information about the coupon, including information about the merchant and the deal to which the coupon relates. The user may select a redeem button 3601 to immediately redeem the coupon. In some embodiments, the user should only do so in the presence of a cashier or other representative of the merchant who is able to subsequently observe the display of the mobile device to review and validate a redemption display. The facility also includes a merchant button 3602 the user can select in order to display additional details about the merchant. The display also includes a give button 3603 that the user may select in order to give this coupon to another user. In step 344, the facility branches on the button selected by the user in this display: if the user selects the locations button, then the facility continues through connector L to step 334 shown in FIG. 3C; if the user selects the give button, then the facility continues in step 345; if the user selects the redeem button, then the facility continues in step 346.

In step 345, the facility presents display 0039, shown in FIG. 42. While the facility is presenting the display, it is seeking to connect to in another mobile device executing the facility, such as wirelessly via Bluetooth, 802.11, or other protocols. If the facility is successful, the facility makes this coupon available for use by the user using the contacted mobile device. In various embodiments, the user giving the coupon continues to have access to it, or ceases to have access to it.

In step 346, if the user confirms that they wish to redeem the coupon, then the facility continues in step 347, else the facility continues through connector G to step 343. In step 347, the facility presents display 0035, shown in FIG. 38. While the facility is presenting the display, the user shows it to the cashier or other representative of the merchant in order to complete the redemption of the coupon. When representative of the merchant sees identifying information 3801 for the merchant, detail 3802 of the corresponding deal; and an animation 3803 that they have been trained to look for in connection with such coupons, the representative is able to determine that the coupon is legitimate and has been consumed by its redemption, and in response provide to the customer the deal to which the coupon corresponds. In step 348, the facility presents display 0036, shown in FIG. 39. The display shows the coupon has been redeemed, and includes button that the user may select in order to post the deal to Facebook (3901), Tweet about the deal (3902), or buy additional coupons (3903). In some embodiments (not shown), in response to the redemption of certain coupons, the facility may offer the user another instance of the coupon, or an instance of another, related coupon.

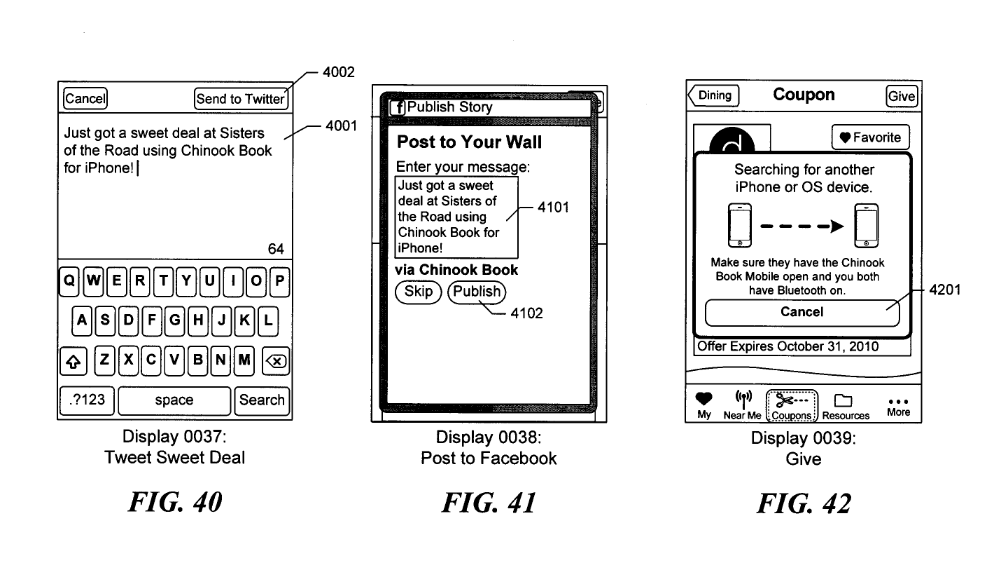

In step 349, the facility branches based upon which button the user selected in display 0036: if user selected the Tweet button, then the facility continues in step 350; if the user selected the post to Facebook button, then the facility continues in step 351; if the user selected another button, the facility proceeds in an appropriate manner. In step 350, the facility presents display 0037, shown in FIG. 40. The display includes a field 4001 containing a default message about the deal, which may be edited by the user. After the user is satisfied with the message, the user selects a send to Twitter button 4002 in order to post the message as a Tweet. In step 351, the facility presents display 0038, shown in FIG. 41. The display includes a field 4101 containing a default message about the deal, which may be edited by the user. After the user satisfied with the message, the user selects a publish to Facebook button 4102 in order to post the message to the user's Facebook wall.

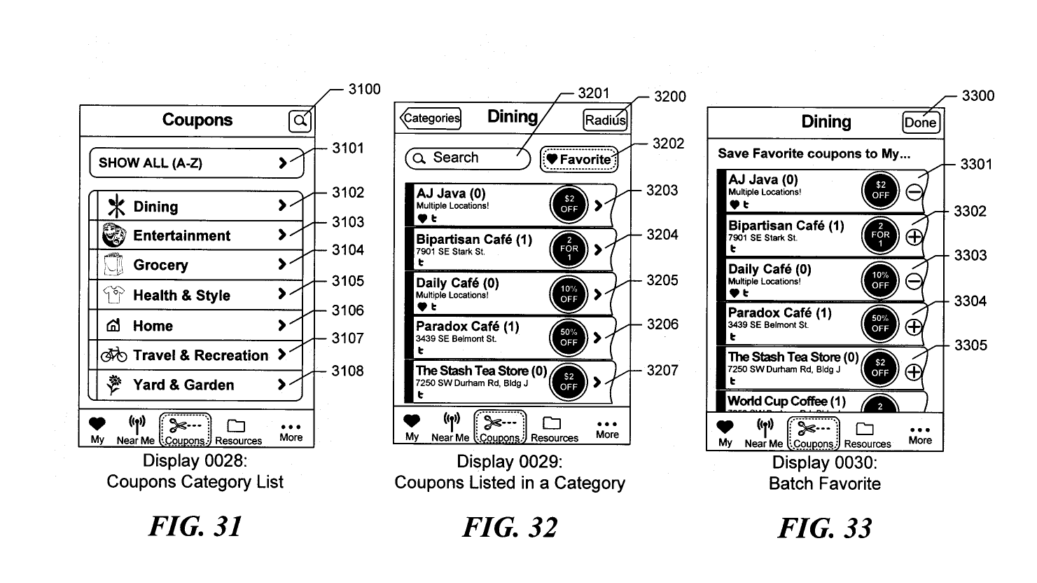

Turning to FIG. 3F, in step 352, the facility presents display 0028, shown in FIG. 31. This display includes a list of coupon categories 3102-3108, any which the user can select in order to display coupons within that category. The display also includes a button 3101 that the user can select in order to display all coupons, irrespective of category. The display also includes a search button 3100 that user may select in order to search for coupons relating to a particular search string. In step 353, the facility presents display 0029 shown in FIG. 32 in response to the user's selection of one of the categories shown in display 0028. This display contains a list 3203-3207 of all of the coupons in the selected category. The display also includes a search field 3201 for conducting a search within this category, and a favorite button 3202 in order to establish this coupon as a favorite of the user's. The play also includes a radius button 3200 that can be selected by the user in order to group the coupons into different radius ranges from the user's present location. In step 354, the facility branches based upon the button selected by the user and display 0029: if the user selects the favorite button, the facility continues in step 355; if the user selects the coupon search button, then the facility continues in step 356; if the user selects the coupon bond, then the facility continues through connector G to step 343 shown in FIG. 3E.

In step 355, the facility presents display 0030, shown in FIG. 33. This display again lists the coupons in the selected category, and allows the user to use controls 3301-3305 to determine whether each of the coupons will be added to the user's favorites when the user selects a done button 3300. After step 355, the facility continues in step 353.

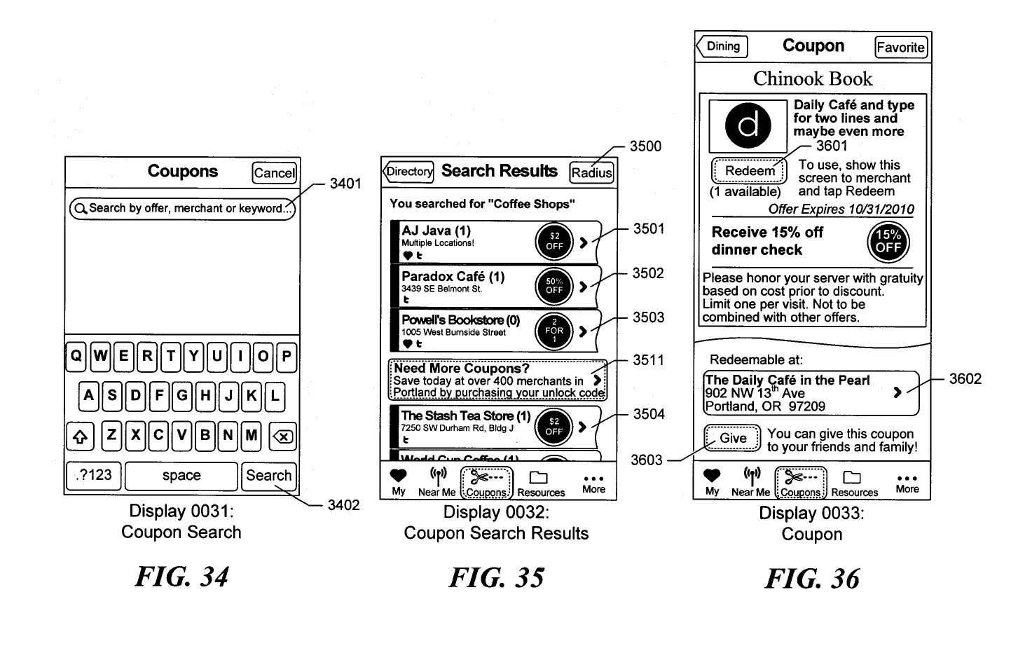

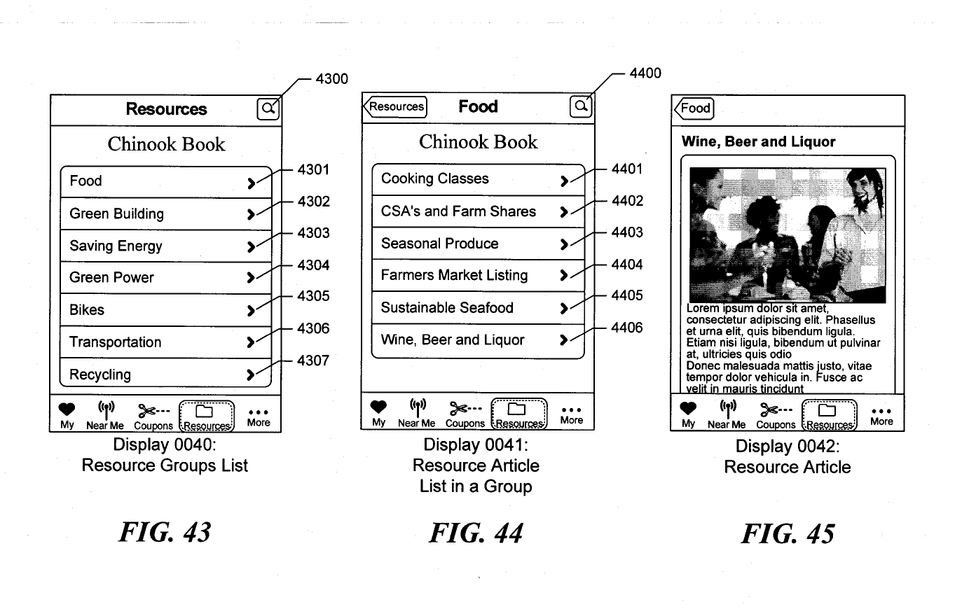

In step 356, the facility presents display 0031, shown in FIG. 34. In this display, the user may enter a search string in query field 3401, then select a search button 3402 in order to search for matching coupons. In step 357, after the user selects the search button the facility presents display 0032, shown in FIG. 35. This display content search results for the search performed by the user in display 0031. In particular, it includes matching coupons 3501-3503 and 3504. The display also includes button 3511 the user can select in order to purchase additional coupons. Paragraph in step 358, the facility presents display 0040, shown in FIG. 43. This display contains a list 4301-4307 of different resource groups to which articles relate. In step 359, when the user selects one of these research groups, the facility presents display 0041, shown in FIG. 44. The display includes a list 4401-4406 of articles available in the selected resource group. In step 360, when the user selects an article from display 0041, the facility presents display 0042, shown in FIG. 45. This display includes the selected article.

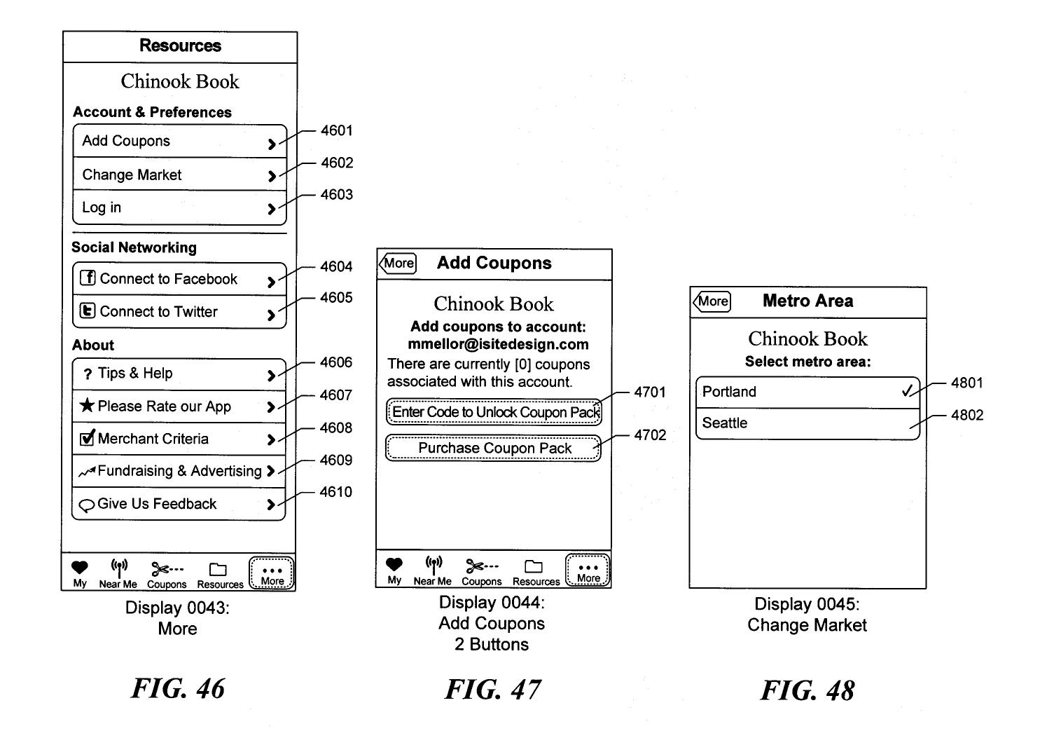

Turning to FIG. 3G, in step 361, the facility presents display 0043, shown in FIG. 46. This display includes a menu of additional aspects of the facility, including a button 4601 that the user can select in order to add coupons; a button 4602 that the user can select in order to change their market; a button 4603 that the user can select in order to log into the facility; a button 4604 that the user can select in order to connect Facebook; a button 4605 that the user can select in order to connect the Twitter; a button 4606 the user can select in order to receive tips and help; a button 4607 that the user can select in order to rate the mobile device application that is provided as part of the facility; a button 4608 the user can select in order to display merchant criteria; a button 4609 the user can select in order to display information fundraising and advertising with the facility; and a button 4610 at the user can select in order to provide feedback to the operators of the facility. In step 362, the facility branches based upon the button selected by the user in display 0043: if the user selects the add coupons button, the facility continues in step 363; if the user selects the change market button, the facility continues in step 364; if the user selects the log in button, the facility continues in step 365; if the user selects the create account button, the facility continues in step 366, if the user selects the Facebook button, the facility continues in step 367; if the user selects the Twitter button, the facility continues in step 368; if the user selects the tips and help button, the facility continues in step 369; if the user selects the rate application button, then the facility continues in step 370; if the user selects the merchant criteria button, the facility continues in step 371; the user selects the fundraising and advertising button, the facility continues in step 372; if the user selects the provide feedback button, then the facility continues in step 373.

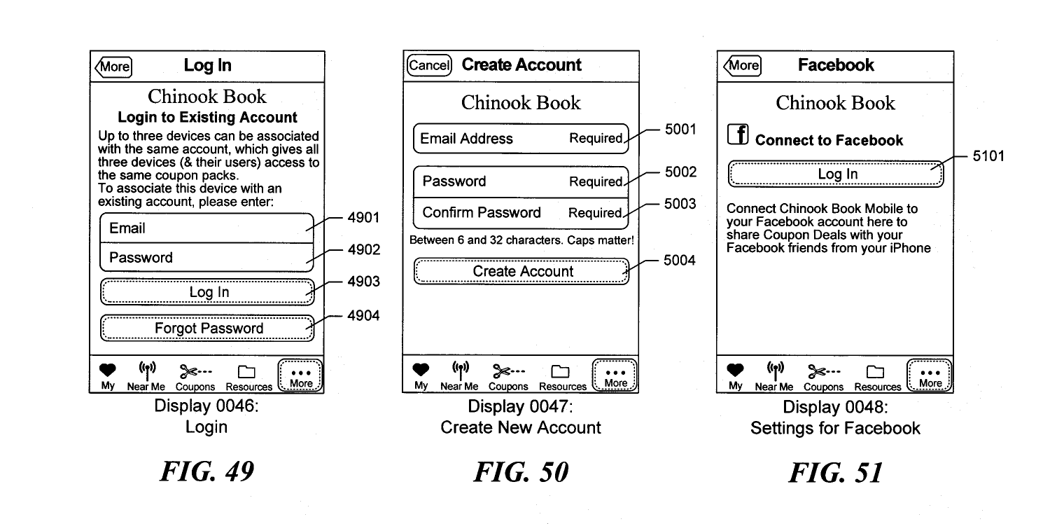

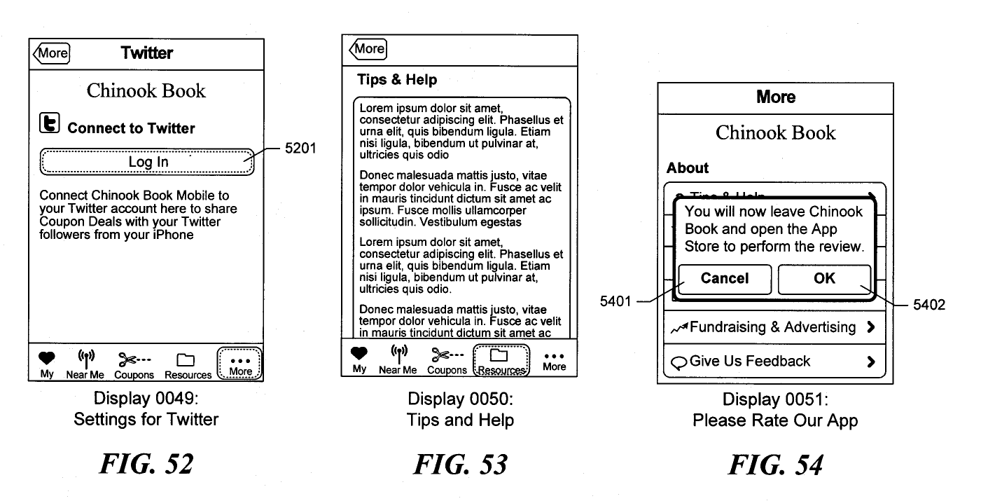

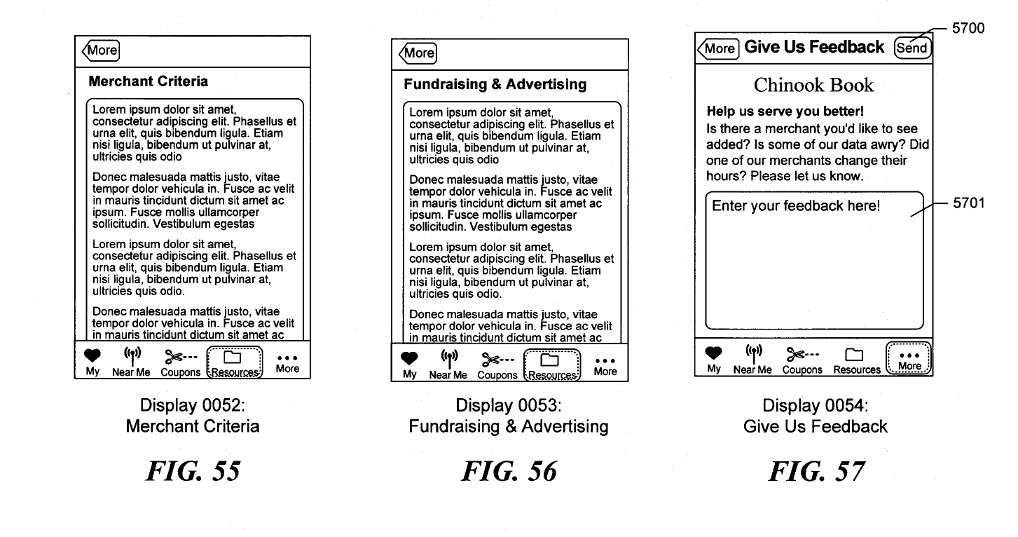

In step 363, the facility presents display 0044, shown in FIG. 47. This display enables the user to purchase or unlock additional coupon packs, and operates in the same manner as described above in connection with display 0010 shown in FIG. 13. In step 364, the facility presents display 0045, shown in FIG. 48. This display allows the user to change market in which the facility is being used, and operates in the same manner as described above in connection with display 0002 shown in FIG. 5. In step 355, the facility presents display 0046, shown in FIG. 49. This display allows the user to login to the facility, and operates in the same manner as described above in connection with display 0019 shown in FIG. 22. In step 366, the facility presents display 0047, shown in FIG. 50. This display enables the user to create a new account, and operates in the manner described above in connection with display 0005, shown in FIG. 8. In step 367, the facility presents display 0048, shown in FIG. 51. This display enables the user to log into their Facebook account by selecting button 5101, in some embodiments by launching a Facebook application on the mobile device. In step 368, the facility presents display 0049, shown in FIG. 52. This display enables the user to log into their Twitter account by selecting button 5201, in some embodiments by launching a Twitter application on the mobile device. In step 369, the facility presents display 0050, shown in FIG. 53. This display includes information to assist the user in using the facility. In step 370, the facility presents display 0051, shown in FIG. 54. This display enables the user to select an okay button 5402 in order to visit a mobile device application store in order to submit a review of the application provided as part of the facility. In step 371, the facility presents display 0052, shown in FIG. 55. The display includes information about criteria applied when selecting merchants to include in the facility. In step 372, the facility presents display 0053, shown in FIG. 56. This display includes information about how to perform fundraising and advertising using the facility. Step 373, the facility presents display 0054, shown in FIG. 57. This display contains a field 5701 into which the user may enter feedback to provide the operators of the facility. When the user selects a send button 5700, this feedback is provided.

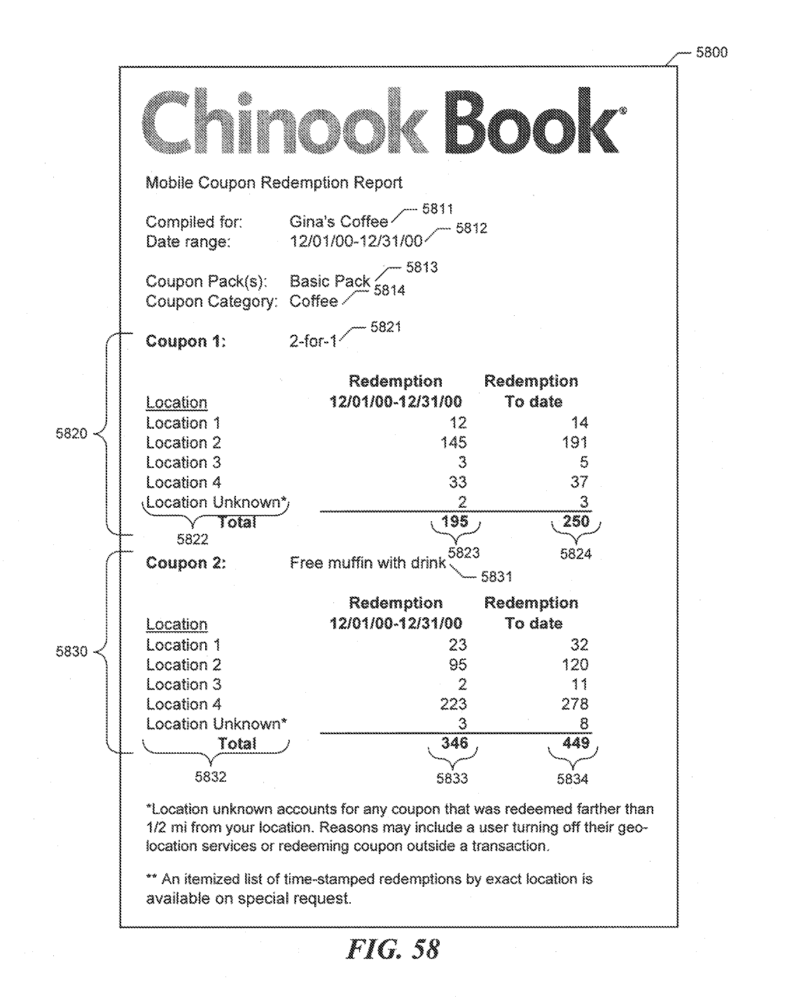

FIG. 58 is a report diagram showing a sample coupon redemption report typical of those generated for a merchant by the facility in some embodiments. The report 5800 contains identifying information for the report, including the name 5811 of the merchant whose coupon redemption is summarized, a date range 5812 for which coupon redemption is summarized, the identity of a particular coupon pack for which coupon redemption is summarized, and a coupon category containing the merchant's coupons. In some embodiments, this date range may be specified by a merchant user. In some embodiments (not shown), the facility includes in the report multiple columns each corresponding to a different date range. The report includes section 5820 containing information about a first, 2-for-1 coupon published by the merchant, and section 5830 containing information about a second, free muffin with drink coupon published by the merchant. Each of these sections indicate, for each of the merchant's locations the total number of the coupon in question that have been redeemed at that location, both during a particular period and since the coupon was first published. The report also indicates redemptions that occurred too far from any of the merchant's locations to be attributable that location area in many cases, these redemptions were accidental, or occurred at a merchant location at a time when the wireless device was unable to accurately determine its location. The merchant can drive a wealth of useful information from this report, including which kinds of coupons are most effective overall, as well as at particular locations.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method in a computing system whose contents are capable of causing a mobile device to perform a method for redeeming an electronic coupon, the method comprising:
receiving user input requesting redemption of the electronic coupon;
in response to receiving the user input:
displaying on a display device information that identifies the electric coupon, identifies a deal associated with the electronic coupon, or describes the deal associated with electronic;
while the information is displayed, on the same display device on which the information is displayed, displaying an animation sequence,
such that a counterfeit electronic coupon corresponding to the electronic coupon cannot be constructed without re-creating the displayed animation sequence.

2. The method of claim 1, further comprising, in response to receiving the user input, providing to the user an additional instance of the electronic coupon.

3. A computer-readable medium having contents adapted to cause a computing system to perform a method for accessing electronic coupon, the method comprising:
generating a prompt to provide unlocking credentials for a coupon pack;
receiving unlocking credentials for the coupon pack; and
in response to receiving the provided unlocking credentials, making a coupon pack comprising a plurality of independently-redeemable electronic coupons available for use, such that the computing system may redeem any of the electronic coupons of the selected coupon pack.

4. The computer-readable medium of claim 3 wherein the unlocking credentials are a textual code.

5. The computer-readable medium of claim 3 wherein the unlocking credentials were purchased.

6. The computer-readable medium of claim 3 wherein the unlocking credentials were received as a promotional consideration.

7. The computer-readable medium of claim 3 wherein the method is performed in a mobile device.

8. The computer-readable medium of claim 3, the method further comprising:
receiving user input requesting redemption of an identified one of the electronic coupons of the selected coupon pack; and
in response to receiving user input requesting redemption of an identified one of the electronic coupons of the selected coupon pack, redeeming the identified electronic coupon.

9. A method for accessing electronic coupon, comprising:
displaying a prompt to enter an unlocking code for a coupon pack;
receiving an unlocking code for the coupon pack entered by a user; and
in response to receiving the provided unlocking code, making a coupon pack comprising a plurality of independently-redeemable electronic coupons available for use by the user, such that the user may redeem any of the electronic coupons of the selected coupon pack.

10. The method of claim 9 wherein the unlocking code was purchased.

11. The method of claim 9 wherein the method is performed in a mobile device.

12. The method of claim 9, further comprising:
receiving user input requesting redemption of an identified one of the electronic coupons of the selected coupon pack; and
in response to receiving user input requesting redemption of an identified one of the electronic coupons of the selected coupon pack, redeeming the identified electronic coupon.

13. A method in a computing system whose contents are capable of causing a mobile device to perform a method for presenting information about electronic coupons, the method comprising:
receiving user input specifying at least one presentation criterion;
retrieving information about each of a plurality of available electronic coupons;
identifying electronic coupons among the plurality whose retrieve information satisfies the specified presentation criterion; and
presenting information about each of the identified electronic coupons.

14. The method of claim 13 wherein the presentation criterion is distance between the mobile device and a location operated by a merchant associated with the coupon.

15. The method of claim 13 wherein the presentation criterion is a category of a merchant associated with the coupon.

16. The method of claim 13 wherein the presentation criterion is a search string.

17. The method of claim 13 when the presentation criterion is whether each coupon should be recommended based upon coupons earlier redeemed using the mobile device.

18. The method of claim 13 wherein the presentation criterion is whether each coupon should be recommended based upon earlier selection of coupons as favorites using the mobile device.

19. The method of claim 13 when the presentation criterion is whether each coupon should be recommended based upon coupons earlier redeemed using other mobile devices associated with the mobile device.

20. The method of claim 13 wherein the presentation criterion is whether each coupon should be recommended based upon earlier selection of coupons as favorites using other mobile devices associated with the mobile device.

21. The method of claim 13 further comprising receiving user input specifying at least one ordering criterion,
wherein the information about each of the identified or, coupons is presented in order that is in accordance with the ordering criterion.

22. The method of claim 13 wherein presenting information about each of the identified electronic coupons comprises displaying a textual list of information about each of the identified electronic coupons.

23. The method of claim 13 wherein presenting information about each of the identified electronic coupons comprises displaying a map including, for each of the identified electronic coupons, an indication of a location of the merchant associated with the identified electronic coupon.
